(19) United States
(12) Patent Application Publication
(10) Pub. No.: US 2022/0187250 A1
(43) Pub. Date: Jun. 16, 2022

(54) VEHICLE SYSTEM AND METHOD TO DETECT TIRE DAMAGE

(71) Applicant: Nexen Tire America Inc., Diamond Bar, CA (US)

(72) Inventors: Dong Y Lee, Copley, OH (US); Aaron Neumann, Hudson, OH (US); Nathan Billy, Medina, OH (US); Lin Kung, Richfield, OH (US)

(21) Appl. No.: 17/121,476

(22) Filed: Dec. 14, 2020

(51) Int. Cl. G01N 29/12; B60C 19/00; G07C 5/02; G01L 17/00; G01N 29/44; G06N 20/00

(52) U.S. Cl. CPC G01N 29/12; B60C 19/00; G07C 5/02; G01L 17/00; G01N 2291/0289; G06N 20/00; B60C 2019/004; B60C 2019/007; G01N 2291/0235; G01N 29/4427

(57) ABSTRACT

A tire damage detection system for a vehicle includes: a tire; at least one sensor disposed in association with the tire to detect a noise signal when the tire rolls on a road surface to move the vehicle, the noise signal having a plurality of frequency peaks in a frequency spectrum of the noise signal; and a processor to monitor target frequency peaks of the frequency spectrum to detect damage of the tire, and to generate an alert signal in response to the detection of the damage of the tire.

### BACKGROUND

### Field

Exemplary implementations of the invention relate generally to a vehicle system, and more specifically, to a vehicle system and a method to detect tire damage.

### Discussion of the Background

In various instances such as when tires impact a large road hazard, or are underinflated, overloaded, and driven in hot climates, the tire may experience damage, which may put the moving vehicle at risk. Especially, internal damage of the tire such as delamination in and/or between internal layers of the tire such as tread layers, belt layers, and carcass layers may occur and propagate while the vehicle runs on the road surface, which eventually can result in abrupt air loss. Abrupt air loss in a tire can cause the vehicle to lose stability, and, in the worst case, cause the vehicle to overturn, which may result in injury or death.

It is useful to know the tire condition at every instant, so a vehicle system may perform processes to obtain measurements that may represent the tire condition and inform the driver of the measurements and/or variations of measurements in real time. However, the internal damage of the tire does not cause any changes in the measurements such as tire pressure detectable by the vehicle system. In this case, the vehicle system cannot inform the driver of any information associated with occurrence of the internal damage of the tire despite the internal damage of the tire puts the running vehicle at serious risk as noted above.

The above information disclosed in this Background section is only for understanding of the background of the inventive concepts, and, therefore, it may contain information that does not constitute prior art.

### SUMMARY

Vehicle systems and methods to detect tire damage according to the principles and exemplary implementations of the invention are capable of performing early and correct detection of damage of the tire to improve vehicle safety. For example, the vehicle system may detect internal damage of the tire based on frequency peaks of a frequency spectrum of a noise signal obtained by at least one sensor disposed in association with the tire.

Additional features of the inventive concepts will be set forth in the description which follows, and in part will be apparent from the description, or may be learned by practice of the inventive concepts.

According to one aspect of the invention, a tire damage detection system for a vehicle includes: a tire; at least one sensor disposed in association with the tire to detect a noise signal when the tire rolls on a road surface to move the vehicle, the noise signal having a plurality of frequency peaks in a frequency spectrum of the noise signal; and a processor to monitor target frequency peaks of the frequency spectrum to detect damage of the tire, and to generate an alert signal in response to the detection of the damage of the tire.

The processor may be configured to: repeatedly determine one of damage levels based on the target frequency peaks; determine a statistical damage level according to the set of the determined damage levels; and generate the alert signal based on the statistical damage level.

The processor may be configured to detect variations of the target frequency peaks of the frequency spectrum based on reference criteria data to detect the damage of the tire.

The processor may be configured to execute a machine learning algorithm associated with the reference criteria data to compare the target frequency peaks with the reference criteria data.

The tire damage detection system may further include a storage medium storing reference criteria data sets corresponding to tire identifiers. The processor may be configured to select at least one of the reference criteria data sets based on input information matched with one of the tire identifiers, and to compare the target frequency peaks with the selected one of the reference criteria data sets.

The target frequency peaks may include some of the plurality of frequency peaks determined by prior controlled experiments.

The tire damage detection system may further include a tire pressure monitoring system. The at least one sensor may be integrated with the tire pressure monitoring system to communicate with the processor through the tire pressure monitoring system.

The noise signal may include an acoustic signal.

According to another aspect of the invention, a method of generating an alert signal to indicate damage of a tire mounted on a vehicle includes steps of: receiving a noise signal from at least one sensor disposed in association with the tire when the tire rolls on a road surface to move the vehicle; generating a frequency spectrum of the noise signal; monitoring target frequency peaks of a plurality of frequency peaks of the frequency spectrum to detect damage of the tire; and generating an alert signal in response to the detection of the damage of the tire.

The monitoring includes steps of: repeatedly determining one of damage levels based on the target frequency peaks; and determining a statistical damage level according to the set of the determined damage levels, and wherein the alert signal is generated based on the statistical damage level.

The monitoring includes a step of: detecting variations of the target frequency peaks of the frequency spectrum based on reference criteria data to detect the damage of the tire.

The comparing includes a step of: executing a machine learning algorithm associated with the reference criteria data to compare the target frequency peaks with the reference criteria data.

The method may further include steps of: accessing a storage medium storing reference criteria data sets corresponding to tire identifiers; and selecting one of the reference criteria data sets based on input information matched with one of the tire identifiers. The comparing may further include a step of comparing the target frequency peaks with the selected one of the reference criteria data sets.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a block diagram of an exemplary embodiment of a vehicle system constructed according to the principles of the invention.

FIG. 2 is a graph of an exemplary frequency spectrum of an acoustic signal from a tire.

FIG. 3 is a table illustrating experimental results of damage levels determined by the damage detector of FIG. 1 for each tire.

FIG. 4 is a view conceptually illustrating an exemplary embodiment of reference data stored in the storage medium of FIG. 1.

FIG. 5 is a cross-sectional view of an exemplary embodiment of a wheel assembly.

FIG. 6 is a block diagram of another exemplary embodiment of the vehicle system.

FIG. 7 is a flowchart of an exemplary embodiment of a method of generating an alert signal to indicate internal damage of a tire according to the principles of the invention.

FIG. 8 is a flowchart of an exemplary embodiment of a method of the step S730 of FIG. 7.

FIG. 9 is a flowchart of an exemplary embodiment of a method of selecting a reference data set.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

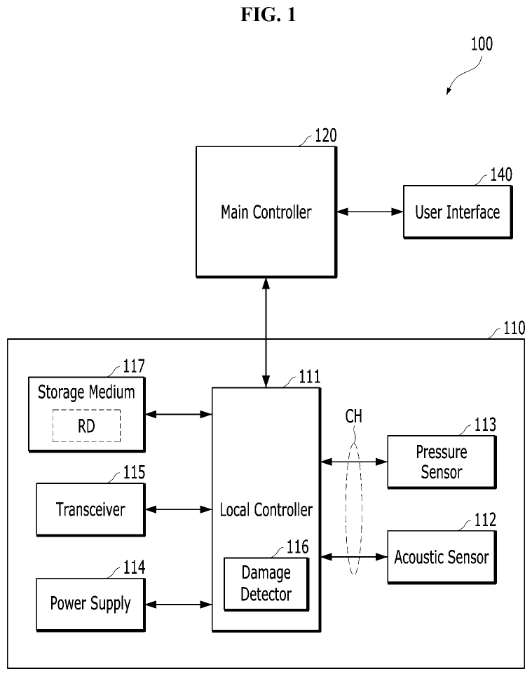

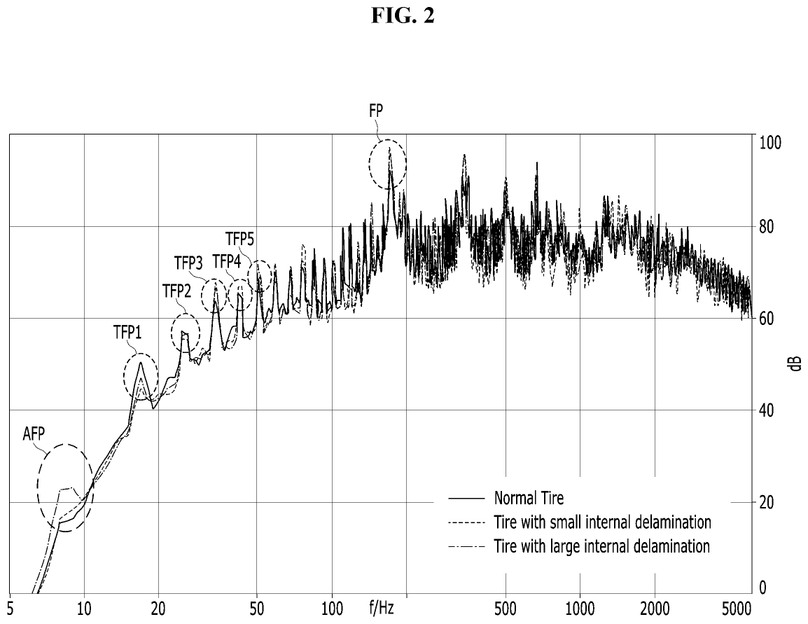

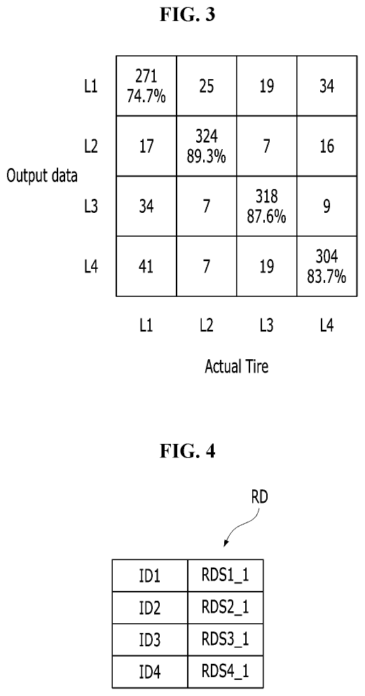

FIG. 1 is a block diagram of an exemplary embodiment of a vehicle system constructed according to the principles of the invention. FIG. 2 is a graph of an exemplary frequency spectrum of an acoustic signal of a tire. FIG. 3 is a table illustrating experimental results of damage levels determined by the damage detector of FIG. 1 for each tire. FIG. 4 is a view conceptually illustrating an exemplary embodiment of reference data stored in the storage medium of FIG. 1.

Referring to FIG. 1, a vehicle system 100 may include a tire damage detection system, a main controller 120, and a user interface 140. The tire damage detection system includes at least one sensor disposed in association with a tire to detect an acoustic signal caused by the tire rolling on a road surface, and detects occurrence of tire damage based on the acoustic signal. The tire damage may be delamination of internal layers of the tire, such as tread layers, belt layers, and carcass layers, which may lead to tire failure and loss of vehicle control, which is significant safety concern. The tire damage detection system may be provided in the form of a tire pressure monitoring system 110 as shown in FIG. 1.

The tire pressure monitoring system 110 may include a local controller 111, an acoustic sensor 112, a pressure sensor 113, a power supply, a transceiver 115, a damage detector 116, and a storage medium 117.

The local controller 111 controls overall operations of the tire pressure monitoring system 110. The local controller 111 and/or the tire pressure monitoring system 110 may operate in response to control signals from the main controller 720. The local controller 111 may be implemented by one or more processors configured to perform the operations and/or functions of the local controller 111 described herein.

The local controller 111 may communicate with the acoustic sensor 112 and the pressure sensor 113. The local controller 111 may process signals, data, and/or information received from the acoustic sensor 112 and the pressure sensor 113. The local controller 111 may transfer the processed signals, data, and/or information to the the main controller 120 through the transceiver 115. The local controller 111 may receive an acoustic signal from the acoustic sensor 112 and generate a frequency spectrum of the acoustic signal over a given frequency interval.

The acoustic sensor 112 may be disposed in association with the tire. In an exemplary embodiment, the acoustic sensor 112 is disposed in a wheel assembly including the tire. The acoustic sensor 112 may detect the noise generated by the tire to provide the acoustic signal to the local controller 111. The acoustic signal may be an analog signal or a digital signal.

In an exemplary embodiment, the acoustic sensor 112 and the pressure sensor 113 may communicate with the local controller 111 through a common channel CH. The acoustic sensor 112 may be integrated with the pressure sensor 113 and/or the tire pressure monitoring system 110. In another exemplary embodiment, the acoustic sensor 112 may be coupled to the pressure sensor 113 to communicate with the local controller 111 through the interface between the pressure sensor 113 and the local controller 111.

In an exemplary embodiment, the acoustic sensor 112 may detect tire vibration caused by the tire. As such, the acoustic sensor 112 may detect various types of a harmonic tire noise caused by the tire to provide a noise signal, such as the acoustic signal, to the local controller 111. The various types of the harmonic noise signal may be used to detect the internal damage of the tire by the local controller 111 in the same manner as the operations using the acoustic signal, described herein.

The pressure sensor 113 may detect air pressure of the tire cavity. The pressure sensor 113 may be mounted on the wheel assembly. The power supply 114 may provide a power source to the components of the tire pressure monitoring system 110. The transceiver 115 may be coupled to the local controller 111 and provide an interface between the local controller 111 and the main controller 120.

The damage detector 116 may be included in the local controller 111. In another exemplary embodiment, the damage detector 116 may be separated from and coupled to the local controller 111. The damage detector 116 may be implemented by at least one of hardware, software, firmware, and combination thereof. For instance, the local controller 111 may be implemented by at least one processor of the local controller 111 which may access and execute software and/or firmware stored in a storage device such as the storage medium 1117 to perform the functions and/or operations of the damage detector 116 described herein. One or more working memories such as Random-Access Memory (RAM) may be associated with the at least one processor to load the software and/or firmware to be executed by the at least one processor. In another exemplary embodiment, the damage detector 116 may be included in the main controller 120 and implemented by the processor of the main controller 120.

Referring to FIG. 2, each of a normal tire, a tire with relatively small internal delamination, and a tire with relatively large internal delamination generates the acoustic signal having a plurality of frequency peaks FP in the frequency spectrum. In FIG. 2, the horizontal axis denotes a frequency in a unit of hertz (Hz) and the vertical axis denotes an energy (e.g., power) level in a unit of dB, which may be an acoustic pressure level.

The internal damage of the tire causes noise generated once per revolution, and the noise causes an additional frequency peak AFP in the frequency spectrum. As such, the normal tire without the internal damage does not cause the additional frequency peak AFP in the frequency spectrum while the tire having the internal damage causes the additional frequency peak AFP. The frequency of the additional frequency peak AFP varies depending on the vehicle speed since it is caused by revolutions of the tire.

Applicant discovered that the internal damage of the tire causes variations of the plurality of frequency peaks FP, and some of the plurality of the frequency peaks FP, such as low order first to fifth target frequency peaks TFP1 to TFP5 having the lowest frequencies from among the plurality of frequency peaks FP, may be recognized and/or detected more easily and correctly than other frequency peaks, and thus may have recognizable and/or detectable variations in response to occurrence of the internal damage of the tire with relatively high reliability.

In an exemplary embodiment, a machine learning algorithm may be used to detect the internal damage based on analysis of the full frequency spectrum. Given that the normal tire without the internal damage also causes the target frequency peaks in the frequency spectrum, the machine learning algorithm may train and/or learn the location and amplitude of the frequency peaks of the normal tire and the damaged tire in controlled experiments. When deployed in the illustrated embodiment, the machine learning algorithm may then detect the internal damage by detecting the variations of the target frequency peaks using the trained and/or learned information of the target frequency peaks.

Referring back to FIG. 1, the damage detector 116 of the local controller 111 may generate the frequency spectrum of the acoustic signal over a given frequency interval and determine target frequency peaks of the frequency spectrum of the acoustic signal. The damage detector 116 may detect a plurality of the frequency peaks in the frequency spectrum in various manners known in the art. In an exemplary embodiment, the damage detector 116 may determine low order frequency peaks having the lowest frequencies from among the plurality of the frequency peaks as the target frequency peaks. For example, the damage detector 116 may determine the five (5) lowest frequency peaks from among the plurality of the frequency peaks as the target frequency peaks.

The damage detector 116 monitors and/or verifies the target frequency peaks to detect the internal damage of the tire. The damage detector 116 may compare the target frequency peaks with reference data RD to detect variation of the target frequency peaks, and generate an alert signal in response to the detection of the variation of the target frequency peaks, which may indicate occurrence of the internal damage of the tire.

The damage detector 116 may include a machine learning algorithm that has trained and/or learned criteria information and/or data for detecting the variation of the target frequency peaks caused by the internal damage of the tire. The machine learning algorithm is trained using controlled experiments that include both normal and damaged tires to obtain the criteria information. The criteria information may be stored in the storage medium 117 as the reference data RD, and the machine learning algorithm of the damage detector 116 may use the reference data RD to detect the internal damage.

The reference data RD may be formed in various manners, and the damage detector 116 may detect variations of the target frequency peaks using the reference data RD in a suitable way according to the form of the reference data RD. For example, the reference data RD may include the criteria information which is associated with the frequency domain, and the damage detector 116 may analyze at least some of the frequency peaks of the frequency spectrum such as the target frequency peaks, and compare the analyzed data with the criteria information to detect the variation of the target frequency peaks.

The damage detector 116 receives frequent inputs from the acoustic sensor 112, and these inputs may include variation of the target frequency peaks due to various variables, such as road surface and other external conditions. The damage detector 116 may then determine a statistical damage level according to the set of the determined damage levels. Referring to FIG. 3, the horizontal axis denotes a damage level of an actual tire, and the vertical axis denotes a damage level of output data of the damage detector 116. The Applicant tested, using the damage detector 116 implemented by the machine learning algorithm, a normal tire represented by a first level L1, a tire with relatively large internal delamination represented by a second level L2, a tire with a medium internal delamination represented by a third level L3, and a tire with a small internal delamination represented by a fourth level L4. For the first level L1 of the tire, the damage detector 116 accurately determined the first level L1 271 times, and the damage detector 116 inaccurately determined the second level L2 17 times, the third level L3 34 times, and the fourth level L4 41 times. Overall, the damage detector 116 accurately determined the first level L1 with 74.7%. For the second level L2 of the tire, the damage detector 116 accurately determined the second level L2 324 times, and the damage detector 116 inaccurately determined the first level L1 25 times, the third level L3 7 times, and the fourth level L4 7 times. In this case, the damage detector 116 accurately determined the second level L2 with 89.3%. For the third level L3 of the tire, the damage detector 116 accurately determined the third level L3 318 times, and the damage detector 116 inaccurately determined the first level L1 19 times, the second level L2 7 times, and the fourth level L4 19 times. The damage detector 116 accurately determined the third level L3 with 87.6%. For the fourth level L4 of the tire, the damage detector 116 accurately determined the fourth level L4 304 times, and the damage detector 116 inaccurately determined the first level L1 34 times, the second level L2 16 times, and the third level L3 9 times. The damage detector 116 accurately determined the fourth level L4 with 83.7%. As such, the damage detector 116 may collect predicted damage levels depending on the variation of the target frequency peaks.

The damage detector 116 may then generate the alert signal in response to the statistical damage level. The damage detector 116 may not generate the alert signal in response to the statistical damage level having relatively low probability. For example, the damage detector 116 may generate the alert signal in response to the statistical damage level that appears with probability higher than a threshold value, such as 70%. The alert signal may include information of the statistical damage level, such as second to fourth levels L2 to L4 of FIG. 3. For example, the alert signal may indicate the second to fourth levels L2 to L4 for the tire of the second to fourth levels L2 to L4, respectively. As such, the damage detector 116 may collect the predicted damage levels to confirm the damage level with statistical accuracy, which may allow the alert signal generated based thereon to have improved reliability.

The target frequency peaks may vary depending on a type of the tire. In an exemplary embodiment, the reference data RD may include reference data sets for a plurality of types of tires having various tire specifications and/or made by the same or different entities. Referring to FIG. 4, the reference data RD includes first to fourth tire identifiers ID1 to ID4 representing first to fourth types of the tire, respectively. The first identifier ID1 is mapped with a first reference data set RDS1_1, the second identifier ID2 is mapped with a second reference data set RDS2 1, the third identifier ID3 is mapped with a third reference data set RDS3 1, and the fourth identifier ID4 is mapped with a fourth reference data set RDS4_1. Referring back to FIG. 1, the damage detector 116 may receive user input information provided by the user through the user interface 140 which may be one or more of devices able to interact with the vehicle system 100. The damage detector 116 may select a reference data set mapped with one of the first to fourth identifiers ID1 and ID4 matched with the user input information, and use the selected reference data set to detect the variation of the target frequency peaks.

The main controller 120 may control overall operations of the vehicle system 100. The main controller 120 may be implemented by at least one processor and/or a memory such as Random Access Memory (RAM) associated with the at least one processor. The main controller 120 may notify the user of a tire problem in response to the alert signal by, for example, displaying visual information and/or generating audio information. Also, the main controller 120 may transfer command signals to other components of the vehicle system 100 in response to the alert signal.

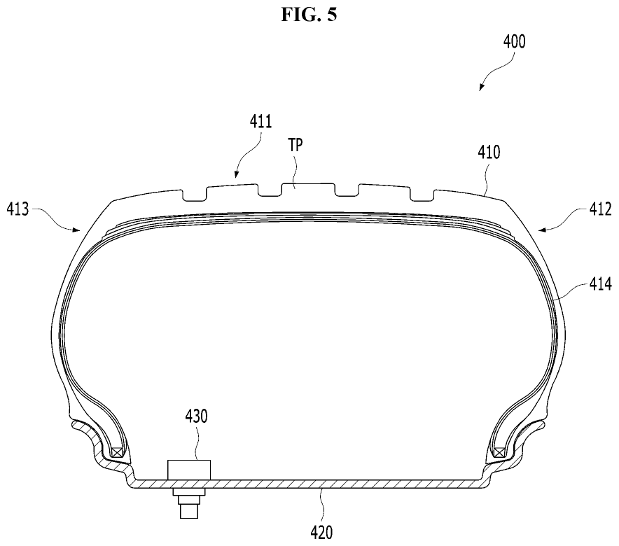

FIG. 5 is a cross-sectional view of an exemplary embodiment of a wheel assembly.

Referring to FIG. 5, a wheel assembly 400 may include a tire 410 and a vehicle wheel 420. The tire 410 is mounted on the vehicle wheel 420 to form the wheel assembly 400.

The tire 410 may include a tread section 411, a pair of sidewalls 412 and 413, and a carcass layer 414. The carcass layer 414 is positioned inside the tread section 411 and the sidewalls 412 and 413, and forms the framework of the tire 410. The carcass layer 414 may define a tire cavity inside the tire 410, and maintain air pressure of the tire cavity to endure load and impact on the tire 410. The carcass layer 414 may include one or more layers overlapping each other. The tread section 411 includes tread patterns TP protruded from the surface of the tire section 411 to contact the ground. The internal damage such as delamination may occur and propagate in these layers of the tire 410 when, for example, the wheel assembly 400 rolls on a road surface.

At least one sensor 430 may be provided in association with the wheel assembly 400. In an exemplary embodiment, the at least one sensor 430 may be mounted on the vehicle wheel 420 to be disposed within an interior of the wheel assembly 400. The at least one sensor 430 may be provided as the acoustic sensor 112 and/or the pressure sensor 113. For example, the acoustic sensor 112 and/or the pressure sensor 113 of FIG. 1 may be integrated with the body of the at least one sensor 430. Also, one or more of other components of the tire pressure monitoring system 110 such as the local controller 111, the power supply 114, the transceiver 115, and the storage medium 117 of FIG. 1 may be integrated with the body of the at least one sensor 430.

In case where the acoustic sensor 112 is disposed in the wheel assembly 400 as shown in FIG. 5, the acoustic sensor 112 may measure the noise generated by the tire 410 that may have the internal damage. Thus, the tire pressure monitoring system 110 and/or the vehicle system 100 using the acoustic signal of the acoustic sensor 112 may perform early and correct detection of the internal damage of the tire.

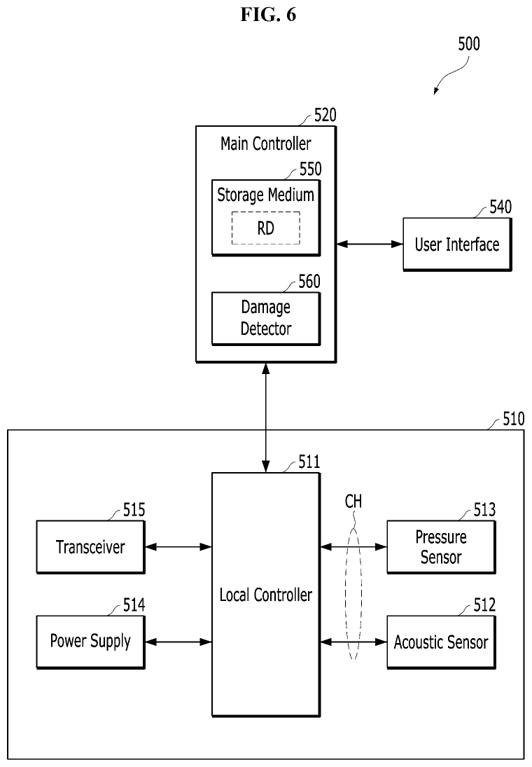

FIG. 6 is a block diagram of another exemplary embodiment of the vehicle system.

Referring to FIG. 6, a vehicle system 500 may include a tire pressure monitoring system 510, a main controller 520, a user interface 540, and a storage medium 550.

The tire pressure monitoring system 510 may include a local controller 511, an acoustic sensor 512, a pressure sensor 513, a power supply 514, and a transceiver 515. The acoustic sensor 512, the pressure sensor 513, the power supply 514, and the transceiver 515 may be configured the same as the acoustic sensor 112, the pressure sensor 113, the power supply 114, and the transceiver 115 of FIG. 1, respectively.

The local controller 511 controls overall operations of the tire pressure monitoring system 510 in response to control signals from the main controller. The local controller 511 may transfer the acoustic signal of the acoustic sensor 512 to the main controller 520 via the transceiver 515. The local controller 511 may process the acoustic signal properly to transfer to the main controller 520.

The main controller 520 controls overall operations of the vehicle system 500. The user interface 540 may be configured the same as the user interface 140 of FIG. 1, respectively. The storage medium 550 stores the reference data RD that may include information the same as the reference data RD of FIG. 1. The storage medium 550 may include various types of non-volatile storage medium and/or volatile storage medium. The reference data RD of the storage medium 550 is accessible to the main controller 520 and/or a damage detector 560.

The main controller 520 may perform at least part of the operations of the local controller 111. The main controller 520 may include the damage detector 560. The damage detector 560 may perform the operations of the damage detector 116 of FIG. 1 to detect internal damage of the tire based on the acoustic signal and/or the frequency spectrum of the acoustic signal provided from the tire pressure monitoring system 510 using the reference data RD. The damage detector 116 may detect variations of target frequency peaks of a frequency spectrum of the acoustic signal by using the reference data RD to detect the internal damage of the tire, and generate an alert signal in response to the detection of the internal damage. In response to the alert signal, the main controller 520 may notify the user of a tire problem and may transfer command signals to other components of the vehicle system 500.

FIG. 7 is a flowchart of an exemplary embodiment of a method of generating an alert signal to indicate internal damage of a tire according to the principles of the invention. Referring to FIG. 7, at step S710, an acoustic signal is obtained from a sensor disposed in association with a tire. The sensor is disposed in the tire, and generates the acoustic signal by detecting a harmonic tire sound when the tire or the wheel assembly rolls to move a vehicle.

At step S720, a frequency spectrum of a power of the acoustic signal is generated over a given frequency interval. The frequency spectrum may include a plurality of frequency peaks. In an exemplary embodiment, the frequency peaks having the lowest frequencies from among the plurality of frequency peaks may be determined as target frequency peaks. For example, the five (5) lowest frequency peaks may be determined as the target frequency peaks.

At step S730, at least some of the frequency peaks, such as the target frequency peaks, are monitored to detect internal damage of the tire. The target frequency peaks may be analyzed and compared with reference data to detect the internal damage. A machine learning algorithm associated with the reference data may be executed by at least one processor to detect variations of the target frequency peaks. For example, the machine learning algorithm may analyze the target frequency peaks and compare the analyzed data with the reference data to detect the variations of the target frequency peaks.

At step S740, an alert signal is generated in response to detection of the internal damage of the tire.

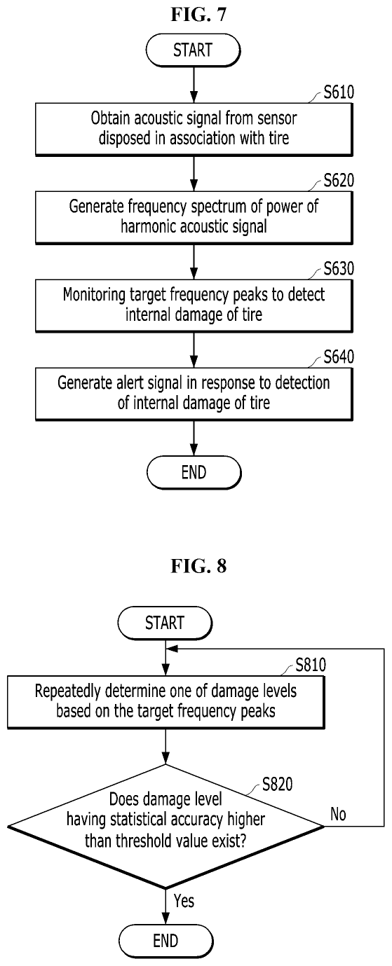

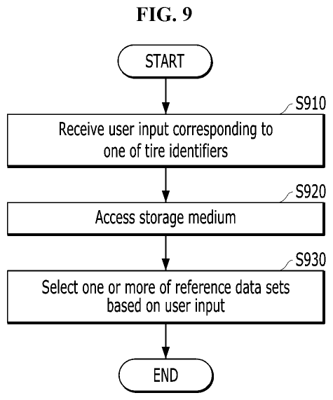

FIG. 8 is a flowchart of an exemplary embodiment of a method of the step S730 of FIG. 7.

Referring to FIG. 8, at step S810, one of damage levels of the tire such as the first to fourth levels L1 to L4 of FIG. 3 is repeatedly determined and/or predicted based on the target frequency peaks and the predicted damage levels are collected. The prediction may be performed a certain number of times.

At step S820, it is determined whether a damage level having statistical accuracy higher than a threshold value exists. The damage level that appears with probability higher than the threshold value may be determined according to the set of data of the predicted damage levels. The set of data may include a certain number of the damage levels predicted at step S810.

The alert signal of the step S740 of FIG. 7 may be generated when the damage level having statistical accuracy exists. The step S810 may be performed when the damage level having statistical accuracy does not exist.

FIG. 9 is a flowchart of an exemplary embodiment of a method of selecting a reference data set.

Referring to FIGS. 3 and 8, at step S910, a user input indicating one of tire identifiers, such as first to fourth tire identifiers ID1 to ID4, is received through a user interface.

At step S920, a storage medium storing reference data is accessed. The reference data may include a plurality of reference data sets, such as the first to fourth reference data sets RDS1_1 to RDS4_1.

At step S930, one or more of reference data sets are selected based on the user input. For example, the first reference data set RDS1_1 is selected when the user input indicates the first tire identifier ID1. The variations of the target frequency peaks of the frequency spectrum may then be monitored based on the selected reference data sets to detect the internal damage of the tire.

The steps of FIGS. 7 to 9 may be performed by the local controller 111 and/or the main controller 120 of FIG. 1 or the local controller 511 and/or the main controller 520 of FIG. 6.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A tire damage detection system for a vehicle comprising:
a tire;
at least one sensor disposed in association with the tire to detect a noise signal when the tire rolls on a road surface to move the vehicle, the noise signal having a plurality of frequency peaks in a frequency spectrum of the noise signal; and
a processor to monitor target frequency peaks of the frequency spectrum to detect damage of the tire, and to generate an alert signal in response to the detection of the damage of the tire.

2. The tire damage detection system of claim 1, wherein the processor is configured to:
repeatedly determine one of damage levels based on the target frequency peaks;
determine a statistical damage level according to the set of the determined damage levels; and
generate the alert signal based on the statistical damage level.

3. The tire damage detection system of claim 1, wherein the processor is configured to detect variations of the target frequency peaks of the frequency spectrum based on reference criteria data to detect the damage of the tire.

4. The tire damage detection system of claim 3, wherein the processor is configured to execute a machine learning algorithm associated with the reference criteria data to compare the target frequency peaks with the reference criteria data.

5. The tire damage detection system of claim 3, further comprising a storage medium storing reference criteria data sets corresponding to tire identifiers,
wherein the processor is configured to select at least one of the reference criteria data sets based on input information matched with one of the tire identifiers, and to compare the target frequency peaks with the selected one of the reference criteria data sets.

6. The tire damage detection system of claim 1, wherein the target frequency peaks comprise some of the plurality of frequency peaks determined by prior controlled experiments.

7. The tire damage detection system of claim 1, further comprising a tire pressure monitoring system,
wherein the at least one sensor is integrated with the tire pressure monitoring system to communicate with the processor through the tire pressure monitoring system.

8. The tire damage detection system of claim 1, wherein the noise signal comprises an acoustic signal.

9. A method of generating an alert signal to indicate damage of a tire mounted on a vehicle, the method comprising steps of:
receiving a noise signal from at least one sensor disposed in association with the tire when the tire rolls on a road surface to move the vehicle;
generating a frequency spectrum of the noise signal;
monitoring target frequency peaks of a plurality of frequency peaks of the frequency spectrum to detect damage of the tire; and
generating an alert signal in response to the detection of the damage of the tire.

10. The method of claim 9, wherein the monitoring comprises steps of:
repeatedly determining one of damage levels based on the target frequency peaks; and
determining a statistical damage level according to the set of the determined damage levels, and
wherein the alert signal is generated based on the statistical damage level.

11. The method of claim 9, wherein the monitoring comprises a step of:
detecting variations of the target frequency peaks of the frequency spectrum based on reference criteria data to detect the damage of the tire.

12. The method of claim 11, wherein the comparing comprises a step of:
executing a machine learning algorithm associated with the reference criteria data to compare the target frequency peaks with the reference criteria data.

13. The method of claim 11, further comprising steps of:
accessing a storage medium storing reference criteria data sets corresponding to tire identifiers; and
selecting one of the reference criteria data sets based on input information matched with one of the tire identifiers,
wherein the comparing further comprises a step of comparing the target frequency peaks with the selected one of the reference criteria data sets.
